(19) United States
(12) Patent Application Publication
(10) Pub. No.: US 2025/0116817 A1
(43) Pub. Date: Apr. 10, 2025

(54) MULTI-WAVEGUIDE OPTICAL EDGE COUPLER HAVING SUB-WAVELENGTH STRUCTURES

(71) Applicant: PsiQuantum, Corp., Palo Alto, CA (US)

(72) Inventors: Eric F. Dudley, Palo Alto, CA (US); Gabriel Joel Mendoza, Mountain View, CA (US); Donggyu Benjamin Sohn, Sunnyvale, CA (US); Gyeongho Son, Albany, CA (US); Mark Thompson, Chester (GB); Mihai Dorian Vidrighin, Palo Alto, CA (US); Sami Ibrahim Halimi, Palo Alto, CA (US)

(21) Appl. No.: 18/912,289

(22) Filed: Oct. 10, 2024

Related U.S. Application Data
(60) Provisional application No. 63/543,490, filed on Oct. 10, 2023.

(51) Int. Cl. G02B 6/30

(52) U.S. Cl. CPC G02B 6/305

(57) ABSTRACT

A photonic circuit can include a multi-waveguide edge coupler to receive light from an external light source. The edge coupler can include planar waveguides and one or more middle waveguides that separate the planar waveguides. The middle waveguides can couple light and have a tapered shape. The planar waveguides can include multiple thin plates that have sub-wavelength thickness, and can be implemented to shape a mode coupled between an external light source and the photonic circuit.

### CLAIM OF PRIORITY

This application claims the benefit of priority to U.S. Patent Application Ser. No. 63/543,490, filed on Oct. 10, 2023, which is incorporated by reference herein in its entirety.

### TECHNICAL FIELD

The present disclosure generally relates to optical devices, and more particularly to coupling light to and from optical devices.

### BACKGROUND

A photonic device can comprise waveguides that direct light. A first waveguide of a first device, such as fiber or an optical chip, can couple light into a second waveguide of another optical chip, however the coupling can be inefficient due to loss and mode mismatch (e.g., a different in sizes and shapes of the optical ports or outputs of the different devices). Further, for some applications, such as high-performance optical networking and quantum optics-based logic devices (e.g., photonic quantum computers), optical degradation of coupled transitions can cause failure of the device to operate (e.g., due to information loss, error rates).

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, or characteristic included in at least one implementation of the inventive subject matter. Thus, phrases such as “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number refer to the figure (“FIG.”) number in which that element or act is first introduced.

FIG. 1 illustrates an edge coupling arrangement, in accordance with some example embodiments.

FIG. 2 shows a cross-sectional view of a multi-waveguide coupler structure in a photonic integrated circuit, in accordance with some example embodiments.

FIG. 3 shows a top-down view of a multi-waveguide coupler, in accordance with some example embodiments.

FIG. 4 shows light propagating in a multi-waveguide coupler, in accordance with some example embodiments.

FIG. 5A and FIG. 5B show example multi-waveguide couplers of a photonic integrated circuit, in accordance with some example embodiments.

FIG. 6 illustrates a pronged multi-waveguide edge coupler in a photonic integrated circuit, in accordance with some example embodiments.

FIG. 7 shows a multi-waveguide structure having a vertical alignment, in accordance with some example embodiments.

FIG. 8 to FIG. 11 show multi-waveguide edge coupling structures having planar waveguides formed from multiple sub-plates, in accordance with some example embodiments.

FIG. 12 is a flowchart of an example method for fabricating a multi-waveguide coupler in a PIC, in accordance with some example embodiments.

FIG. 13 shows an example method for implementing a multi-waveguide coupling structure, in accordance with some example embodiments.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

In some example embodiments, a photonic integrated circuit (PIC) can include a multi-waveguide edge coupler to facilitate efficient coupling of light into and out of the PIC. In some example embodiments, the multi-waveguide edge coupler includes planar waveguides and a plurality of intermediate waveguides positioned between the planar waveguides.

In one embodiment, the planar waveguides are structures formed from multiple thin plates, each having thickness below the wavelength of light that propagates in the PIC (e.g., infrared light). The multiple thin sub-plates can have different cross sectional arrangements such that the mode size of the multi-waveguide structure matches the mode size of the light being coupled to the edge interface, such as a circular mode from an external fiber or an elliptical shaped mode from an external light source (e.g., semiconductor laser).

In some example embodiments, the intermediate waveguides are in the center between the planar waveguides, aiding in the shaping and transmission of optical modes between an optical device (e.g., fiber, source chip) and the photonic integrated circuit. The intermediate waveguides can have arcing or bent shapes that can arc outwardly or inwardly to couple light and center the light such that the mode of the light is reduced and coupled to the PIC in a low loss fashion with reduced mode mismatch (e.g., loss as low as 11 mdB). In this way, light can be coupled to a photonic integrated circuit (e.g., chip) in a highly performant low-loss manner, making it suitable for high-efficiency optical communication and photonic processing applications, such as modern optical-based telecommunications devices, optics based artificial intelligence chips (e.g., optical inference networks), and photonic quantum computing chips.

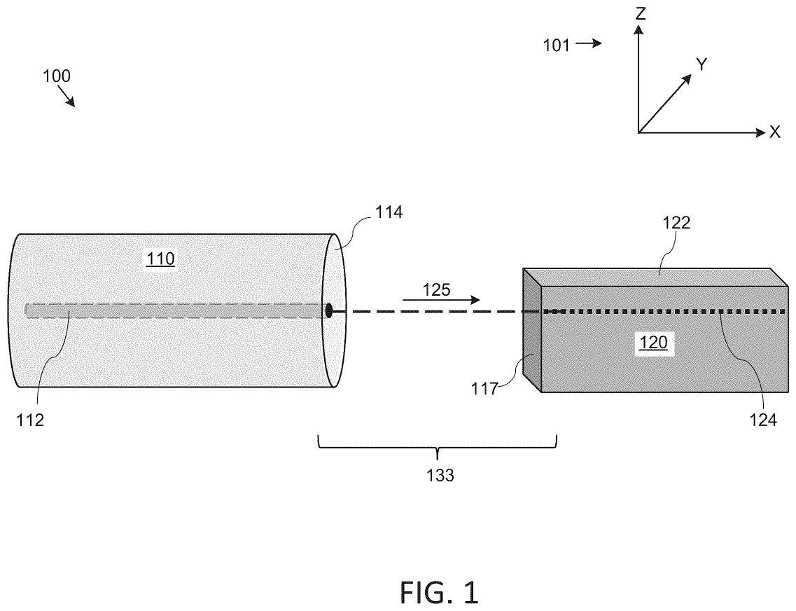

FIG. 1 shows an edge coupling arrangement 100 from a side perspective view, in accordance with some example embodiments. In the example of FIG. 1, a dimension legend 101 shows the three dimensions, X, Y, and Z, with respect to the following figures. For example, optical and electrical devices (e.g., photonic integrated circuits (PICs), electrical chips) can have a planar form in the XY plane, where the optical waveguides or electrical traces are laid out generally parallel (e.g., approximately parallel) to the XY plane. A given optical and/or electrical device may comprise multiple planar layers (e.g., different layers of silicon, cladding, and so on), where vertical paths (e.g., up/down, along the Z-axis) between different planar layers can be implemented by vias (e.g., to connect electrical paths) or internal PIC optical transitions (e.g., internal PIC tapers).

In FIG. 1, a photonic integrated circuit 120 (PIC) is illustrated having a topside 122 extending laterally along the XY plane, and edges (e.g., sides, facets), such as edge 117, into which light can be coupled laterally along an input direction 125 (e.g., injection direction, parallel to the XY plane); although one of ordinary skill appreciates that light can be received out of the edge 117 in a direction opposite of the arrow of the input direction 125 (e.g., the PIC 120 couples, or transmits, light out to an external device, such as another PIC or fiber), in accordance with some example embodiments.

In the example of FIG. 1, the edge coupling arrangement 100 shows an optical fiber 110 (e.g., single mode fiber (SMF), SMF-28 that is coupled to the PIC 120. One advantage of edge coupling is that it can be efficient: a given a topside or bottom-side of a PIC may be difficult to access or may not have space in the layout design for the addition of gratings or parallel-tapers implemented in evanescent-style coupling, whereas the edge or side of the PIC may be accessible in those same PIC designs. Additionally, edge coupling can provide very low loss optical coupling as compared to other approaches.

In the illustrated example, the optical fiber 110 includes a core 112 (e.g., core layer), and a cladding 114 (e.g., cladding layer) that surrounds the core 112. The core 112 is configured to transmit light (e.g., radiation, visible light, UV radiation, IR radiation) along the length (e.g., along the axis) of the optical fiber 110. The optical fiber 110 may include any type of optical fiber. For example, the optical fiber 110 may comprise a glass optical fiber in which the core 112 comprises a glass layer, and the cladding 114 comprises a different glass layer having a lower refractive index than the core 112 such that the light is substantially confined and propagates in the core 112.

In some example embodiments, the PIC 120 is an optical die or chip formed from planar layers of materials (e.g., silicon, silicon nitride, silicon dioxide, III-V materials, etc.) that have different refractive indices such that light can propagate in waveguides of the PIC 120. In the example of FIG. 1, the PIC 120 has a topside 122 and an edge 117, though it is appreciated by one of ordinary skill that the topside 122 is with respect to the view of FIG. 1. The topside 122 is planar and substantially parallel with the XY plane. The topside 122 is at an angle to the edge 117 (e.g., orthogonal, at 90 degrees). By axially aligning the core 112 of the optical fiber 110 and the waveguide 124 of the PIC 120, light can be coupled to and from the edge 117 in an edge coupling region 133. The optical fiber 110 may be positioned and axially aligned to the PIC 120 using one or more alignment techniques (e.g., active alignment, passive marker-based (fiduciary-based) placement and alignment), or by way of a fiber mount that holds the optical fiber 110 in position (e.g., a moveable fiber holder, a v-groove structure of a fiber holder chip).

In some example embodiments, after alignment, the optical fiber 110 is permanently attached to the PIC 120. Attachment approaches can include adhesive-based approaches (e.g., using epoxy, solder, glass seal, silicone-based optically clear adhesive), fusing or melting the fiber to the PIC, or a socket-based approach in which the optical fiber 110 and the PIC 120 have congruent interlocking shapes that hold the optical fiber 110 in place (e.g., with respect to the PIC 120). In some example embodiments, the core 112 of the optical fiber 110 is larger in diameter than the diameter of the waveguide 124 of a PIC 120 such that modes are mismatched (e.g., beam waist mismatch) which can cause optical performance degradation. To reduce issues from mode mismatch, in some example embodiments, a spot size converter is integrated into the edge coupling arrangement 100. For example, the PIC 120 can include optical features, such as tapers in the waveguide 124, to reduce the difference between the mode sizes or slowly transition light from a larger mode size of the optical fiber 110 to the waveguide mode size of the waveguide 124.

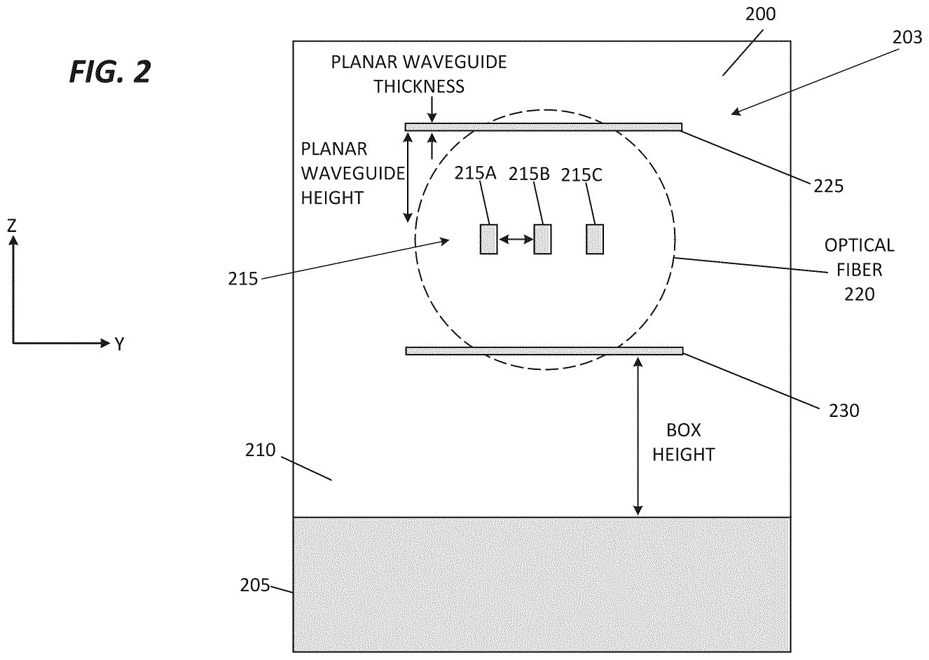

FIG. 2 shows a cross-section view (YZ plane) of a multi-waveguide coupler 203 in a PIC 200, in accordance with some example embodiments. In the view of FIG. 2, light (e.g., classical light, quantum light, single photons, squeezed light) propagates in and out of the page. In the illustrated example, the PIC 200 comprises a substrate 205 (e.g., silicon substrate, glass), and cladding material 210 (e.g., oxide material, silicon dioxide) in which the multi-waveguide coupler 203 is embedded. A mode size 220 of an optical fiber is illustrated as dashed circle. The multi-waveguide coupler 203 includes a plurality of outer waveguides, including a first planar waveguide 225 (e.g., 10-35 nanometers thick, where thickness is in the “Z” dimension in FIG. 2) and a second planar waveguide 230 (e.g., 10-35 nanometers thick), that are separated by a plurality of middle waveguides 215 (e.g., inner waveguides). In some example embodiments, each of the middle waveguides 215 have a thickness (in Z dimension) of 100-350 nanometers, and a width (in Y dimension) from 100-150 nanometers. In some example embodiments, the lower oxide cladding layer (“BOX Height”) is 10 to 15 μm thick to avoid substrate leakage and/or mode distortion from the substrate 205.

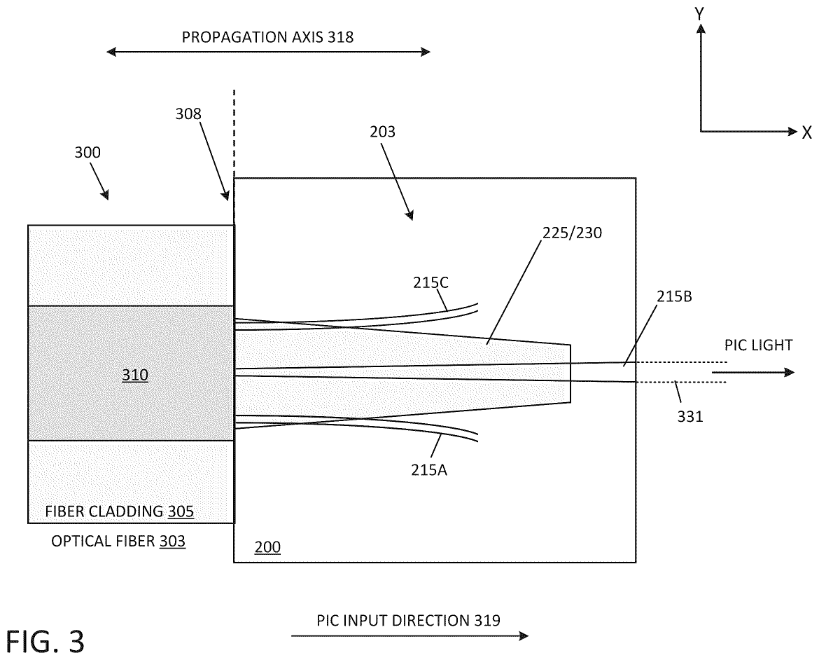

In some example embodiments, the waveguides of the multi-waveguide coupler 203 comprise silicon-based waveguides (e.g., silicon waveguides, silicon nitride (SiN) waveguides). In some example embodiments, the plurality of middle waveguides 215 includes a first side waveguide 215A, a center waveguide 215B, and a second side waveguide 215C, each separated by cladding material (e.g., gaps of 2-10 μm). In some example embodiments, the waveguides in the center (e.g., waveguides 215) are separated from the top and bottom planar waveguides (first planar waveguide 225 and second planar waveguide 230) by 2-5 μm of cladding. In some example embodiments, the middle waveguides comprise an additional upper layer of middle waveguides (not depicted), such as three additional waveguides of similar form and shape as the plurality of middle waveguides 215 positioned a few microns above (in Z dimension) the plurality of middle waveguides 215, and/or a further lower layer of middle waveguides positioned a few microns below the plurality of waveguides 215, where the additional layers of middle waveguides can taper-in or narrow as they extend away from the edge interface to couple light to the center most of the middle waveguides as the light propagates away from the edge interface. In some example embodiments, the composite mode size (e.g., supermode) from each component of the multi-waveguide coupler 203 reduces mode mismatch between the PIC 200 and the coupled-to device (e.g., fiber). Although the plurality of middle waveguides 215 are illustrated as grouped in a center or middle portion of the multi-waveguide coupler 203, in some example embodiments, the gaps between the center and side waveguides (denoted by “gap” in FIG. 2) is increased, such that the side waveguides may be closer to the perimeter of the multi-waveguide coupler 203, as shown in the example of FIG. 3. In some example embodiments, the components of the multi-waveguide coupler 203 can be formed using semiconductor based manufacturing techniques (e.g., lithography, etching, deposition of cladding, polishing). In some example embodiments, the thin plate structures (e.g., first planar waveguide 225, second planar waveguide 230) are formed using vapor deposition (e.g., thin film deposition, chemical vapor deposition (CVD), atomic layer deposition (ALD)).

FIG. 3 shows a top down view 300 in the XY plane of the multi-waveguide coupler 203 of the PIC 200, in accordance with some example embodiments. In the example of FIG. 3, the PIC 200 is coupled to an optical fiber 303 (e.g., single mode fiber (SMF); optical fiber 110, FIG. 1) at an edge coupling interface 308. In the illustrated example, the optical fiber 303 has a fiber cladding portion 305 and a fiber core portion 310 to propagate light in the optical fiber 303. Light, such as quantum light (e.g., single photons, photons of a quantum state, squeezed light) or classical light (e.g., thermal light, bright light, laser light), can be coupled to and from the PIC 200 along a propagation axis 318. For example, light can be input from the optical fiber 303 to the PIC 200 in the PIC input direction 319, and coupled out of the PIC (e.g., to the fiber, to free space, to another chip) in a PIC output direction, with respect to the edge coupling interface 308 (e.g., the propagation axis 318, input direction, output direction may be normal to the edge coupling interface 308 at the edge of the PIC 200), in accordance with some example embodiments.

In the view of FIG. 3, the first and second planar waveguides 225 and 230 are aligned from the top down view. Thus, although one of them is visible (e.g., first planar waveguide 225), FIG. 3 shows both reference numbers “225 and 230” for illustrative purposes. In some example embodiments, each of the planar waveguides 225 taper-in or narrow in the PIC input direction 319. For example, first planar waveguide 225 (and second planar waveguide 230) can be 5-10 μm wide near the edge coupling interface 308, and 3-6 μm at the far side in the PIC. Each planar waveguide 225 and 230 can have a length (X dimension) of 500 to 1500 μm over which to decrease from the larger width near the edge coupling interface 308 to the smaller width at the far side in the PIC.

In some example embodiments, the plurality of middle waveguides 215 have an increasing taper, that is, a taper that increases in width with respect to the PIC input direction 319. For example, the first side waveguide 215A and second side waveguide 215C can arc outward away from the center waveguide 215B such that the mode is substantially transferred to the center waveguide 215B. In practice, such a taper can cause the overall mode size to be reduced from the large mode size (e.g. of the fiber mode in fiber core portion 310) to the smaller mode size (e.g., a mode size of the routing waveguide 331). Further, although in the illustrated examples, only the multi-waveguide coupler is illustrated as being in the PIC (e.g., PIC 200), it is appreciated that only a portion of the PIC is illustrated to show details of the multi-waveguide coupler, and the PIC can include other optical components (e.g., detectors, phase shifters) connected by waveguides (e.g., routing waveguide 331, routing waveguide 550, routing waveguide 650).

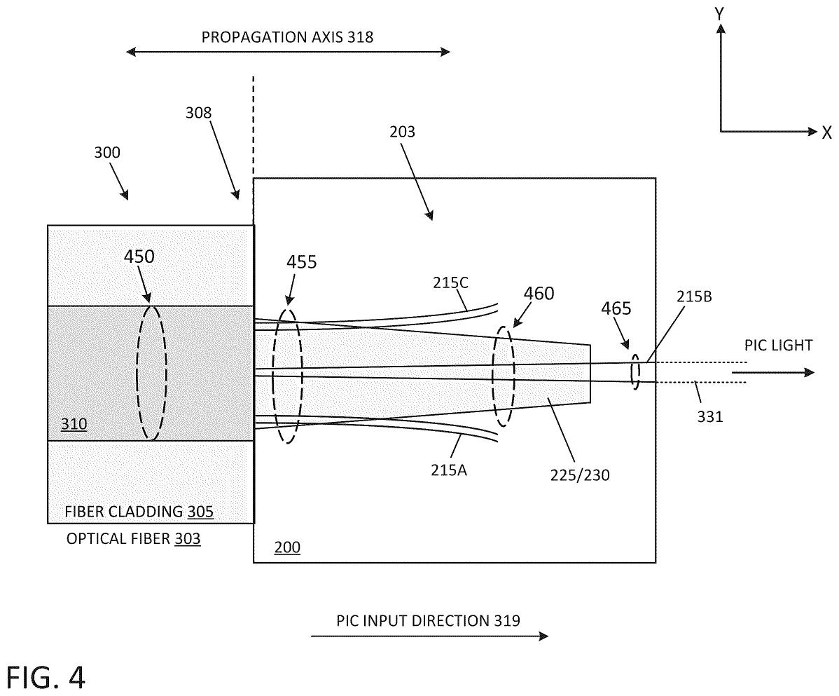

FIG. 4 shows an example of light being coupled using the multi-waveguide coupler 203, in accordance with some example embodiments. In illustrative example of FIG. 4, the light in the fiber 303 has a mode size 450 (e.g., dashed circle) that corresponds to the width of the fiber core portion 310. For example, the fiber 303 can be single mode fiber (e.g., SMF-28) having a mode size of 8 to 12 μm, or can be multimode fiber having a mode size of 40 to 60 μm. The light is coupled into the PIC 200 at an edge coupling interface 308. Due to the physical size and placement of the components of the multi-waveguide coupler 203 the mode sizes match and mode-size based loss is reduced, as shown by the mode size 455 in the left side of the multi-waveguide coupler 203.

As the light propagates in the PIC input direction 319, the shape, size, and placement of the components of the multi-waveguide coupler 203 function in concert to adiabatically convert the mode size to smaller mode sizes, as shown by the mode size 460 and mode size 465, in a low loss spot conversion manner. At the end of the coupler (e.g., right side of PIC 200 in FIG. 4) the mode size is the size of the routing waveguide 331 (e.g., waveguide 124, FIGS. 1, 200 to 500 nanometers in width and height; a magnitude less in size than the fiber mode size). In this way, mode-mismatch based loss is avoided due to the multi-waveguide coupler 203 having simile mode size (e.g., mode size 455) near the edge coupling interface 308, and loss is avoided during spot conversion (from larger to smaller mode) by adiabatically coupling the light through the multi-waveguide coupler 203.

Although for explanatory purposes light is coupled from the optical fiber 303 to the PIC 200, it is appreciated that the same processes and structures can couple light out of the PIC. For example, light can be coupled from the routing waveguide 331 to the multi-waveguide coupler 203 and out of the PIC (e.g., to the optical fiber 303, to another PIC, to free space). Additional embodiments are discussed below and can have dimensions similar or the same as the embodiments discussed above (e.g., FIGs, 2, 3, 4), or have further details of shapes and dimensions, as discussed below.

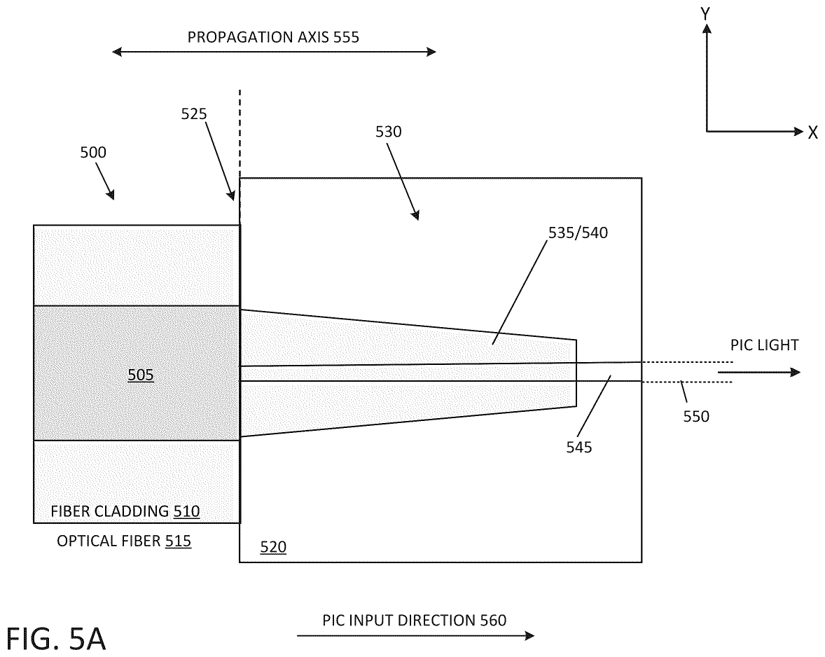

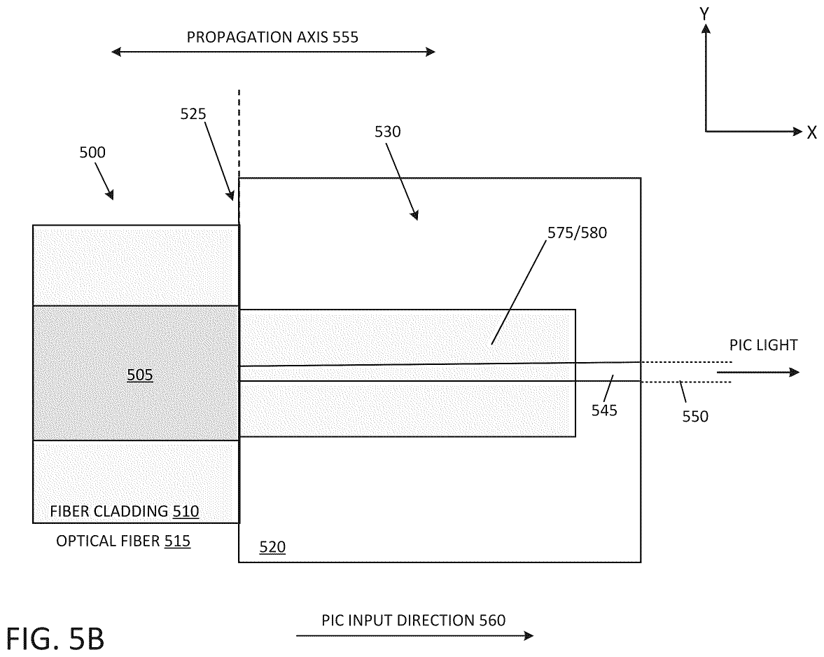

FIG. 5A shows a top down view (XY plane) of a multi-waveguide coupler structure 530 of a photonic integrated circuit 500, in accordance with some example embodiments. In the example of FIG. 5A, the photonic integrated circuit 500 is coupled to an optical fiber 515 (e.g., single mode fiber (SMF)) at an edge coupling interface 525. In the illustrated example, the fiber 515 has a fiber cladding portion 510 and a fiber core portion 505 with different indices such that light propagates in the fiber core portion 505 within the optical fiber 515. Light, such as quantum light (e.g., single photons, entangled photonic states, squeezed light) or classical light, can be coupled to and from the photonic integrated circuit 500 along a general propagation axis 555 (e.g., normal or orthogonal from the edge or side of the PIC). For example, the light can be input from the optical fiber 515 to the photonic integrated circuit 500 in the photonic integrated circuit input direction 560, and coupled out of the PIC 520 (e.g., to the fiber, to free space) in direction opposite of the input direction 560, with respect to the edge coupling interface 525, in accordance with some example embodiments.

In the view of FIG. 5A, a first planar waveguide 535 and a second planar waveguide 540 are aligned and only one of them is visible (e.g., first planar waveguide 535), though both are labeled with reference numbers “535/540” for illustrative purposes. In some example embodiments, each of the planar waveguides 535/540 taper-in or narrow in the photonic integrated circuit input direction 560. For example, the planer waveguides can be 5 to 10 μm wide near the edge coupling interface 525, and 3 to 6 μm wide at the far side of the planar waveguides (e.g., the side farthest way from the edge coupling interface 525). In some example embodiments, the first and second planar waveguides are not tapered, but are rectangular planar structures 575/580 with no tapering (e.g., having a width of 8 μm in Y dimension, and lengths of 500 to 1500 μm in X dimension), as illustrated in FIG. 5B.

In the illustrated example of FIG. 5A, the multi-waveguide coupler structure 530 comprises a single middle waveguide 545 that is between the planar waveguides 535/540. In some example embodiments, the middle waveguide 545 comprises an increasing taper (e.g. a taper that increases in width along the input direction 560). At the edge coupling interface 525, the combined mode size of the first planar waveguide 535 (e.g., first plate), second planar waveguide 540 (e.g., second plate), and middle waveguide 545 are congruent (e.g., match or approximately match) with a mode size of the fiber mode coupled to the multi-waveguide coupler structure. The light propagating in the multi-waveguide coupler structure 530 can be coupled out of the multi-waveguide coupler structure 530 to other components of the PIC 520 by way of routing waveguide 550 (e.g., to a single photon detector, phase shifter, or other components in the PIC 520 (not depicted)).

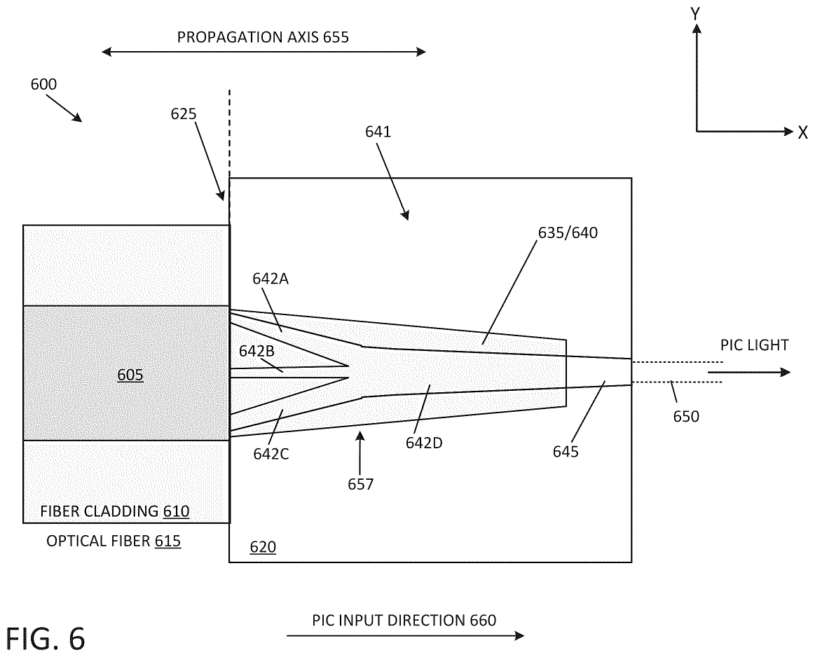

FIG. 6 shows a top down view 600 (XY plane) of a PIC 620 having a multi-waveguide coupler structure 641, in accordance with some example embodiments. In the example of FIG. 6, the PIC 620 is coupled to an optical fiber 615 comprising a core 605 and a fiber cladding 610. Although in some illustrative examples discussed here, a fiber is implemented to couple light to the edge for coupling to the PIC, other types of optical devices, such as semiconductor laser PICs can provide the light (e.g., a light source PIC can be edge coupled such that light from an edge output from the laser is coupled to the PIC 620).

Continuing, in the example illustrated in FIG. 6, light can be coupled from the fiber 615 into the PIC 620 along a propagation axis 655 into an edge of an edge coupling interface 625. For example, light can be coupled from the fiber 615 into the PIC 620 along a PIC input direction 660, or coupled out of the PIC 620 in an opposite direction. In the example of FIG. 6, the top and bottom planar waveguides 635 and 640 are aligned from the perspective of FIG. 6, thus as discussed above only one of the planer waveguides is depicted. In the example of FIG. 6, the center waveguide structure 645 comprises a trident arm structure having a first arm 642A, a second arm 642B, and third arm 642C, which coalesce at joining portion 657 into a center arm 642D (e.g., the joining portion 657 is 300 to 600 μm away from the edge coupling interface 625). In some example embodiments, the combined mode size of the planar waveguides 642A-642D are more congruent to the mode size of the fiber 615 such that light is efficiently edge coupled between the fiber 615 and the PIC 620.

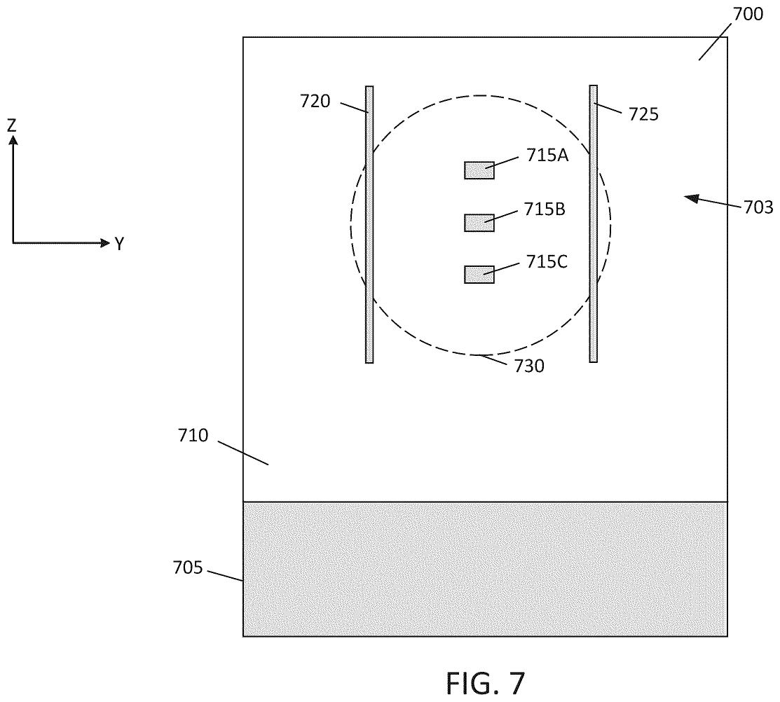

FIG. 7 shows a cross-section view (YZ plane) of a photonic integrated circuit 700 having a multi-waveguide coupler structure 703, in accordance with some example embodiments. In the example of FIG. 7, light propagates in and out of the page. In the illustrated example, the photonic integrated circuit 700 comprises a substrate 705 (e.g., silicon substrate, glass), on which cladding material 710 (e.g., oxide material, silicon dioxide) is deposited. A multi-waveguide coupler structure 703 is surrounded by the cladding material 710, where the difference of indices of refraction between the cladding and the waveguide material confines the light to the multi-waveguide coupler structure 703. The multi-waveguide coupler structure 703 can be formed from materials such as silicon or silicon nitride. In some example embodiments, the components of the multi-waveguide coupler structure 703 are deposited via vapor deposition (e.g., thin film deposition, chemical vapor deposition (CVD)) and/or lithography.

In the view of FIG. 7, similar to FIG. 2, is cross-sectional view at an edge coupling interface (e.g., 308, 525, 625) between a fiber that is coupled to an edge or side of the photonic integrated circuit. In contrast to FIG. 2, the multi-waveguide coupler structure 703 is oriented vertically (e.g. along the Z axis) such that a first planar waveguide 720 and a second planar waveguide 725 are parallel or approximately parallel to one another. Similarly, a plurality of one or more center waveguides are oriented between the planer waveguides 720 and 725, such as center waveguides 715A, 715B, and 715C. As discussed above, the combined super mode of the multi-waveguide coupler structure 703 is congruent with the mode size 730 of the light being coupled in and out of the PIC such that light can be efficiently coupled between the photonic integrated circuit 700 and the fiber (not depicted in FIG. 7) while minimizing optical issues such as mode mismatch and optical loss.

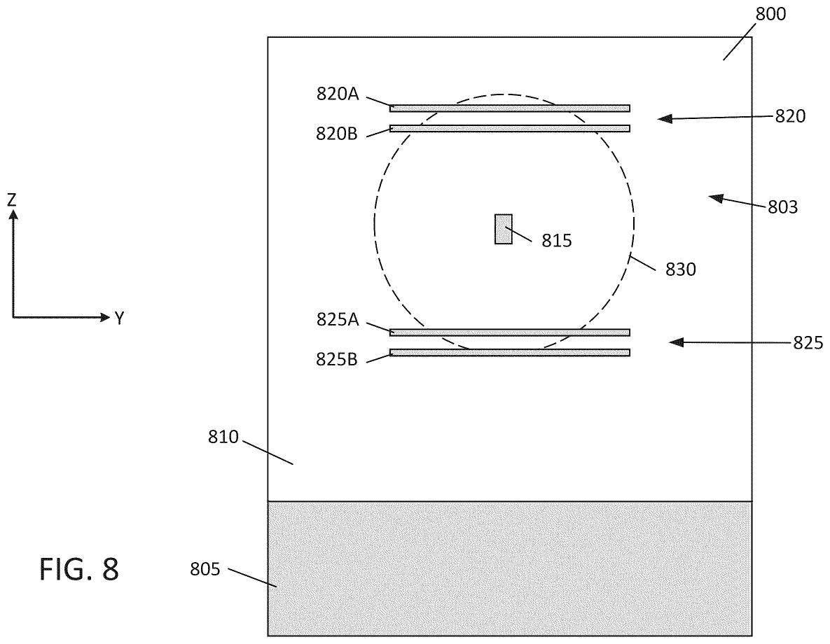

FIG. 8 shows a cross section view (YZ plane) of PIC 800 comprising a multi-waveguide coupler structure 803 having sub-wavelength plates, in accordance with some example embodiments. In the illustrated example of FIG. 8, the PIC 800 comprises a substrate 805 and cladding material 810 in which the multi-waveguide coupler structure 803 is located. The multi-waveguide coupler structure 803 comprises a first plate structure 820, a second plate structure 825, and center single waveguide 815. In some example embodiments, the collective mode size (e.g., cross sectional) of the multi-waveguide coupler structure 803 is congruent with the fiber mode size 830 such that light is efficiently coupled between the fiber (not depicted in FIG. 8) and the PIC 800. In the example of FIG. 8, the first plate structure 820 and second plate structure 825 are formed from sub-wavelength plates. For example, the first plate structure 820 comprises a first sub-plate 820A and second sub-plate 820B that are thin enough to be below the wavelength of light coupled to the PIC (e.g., IR light; light having a wavelength of 1530 nanometers), where collectively the first sub-plate 820A and the second sub-plate 820B are “seen” by the light as single planar waveguide. That is for, example, collectively the first plate structure 820 functions similar to the first planar waveguide 225 in FIG. 2 but with further mode matching and mode shaping available by the size and position of the first sub-plate 820A and the second sub-plate 820B. Similarly, the second plate structure 825 comprises sub-wavelength plates including a first sub-plate 825A and a second sub-plate 825B that are similarly seen by the light as a single plate (e.g., second planar waveguide 230, FIG. 2).

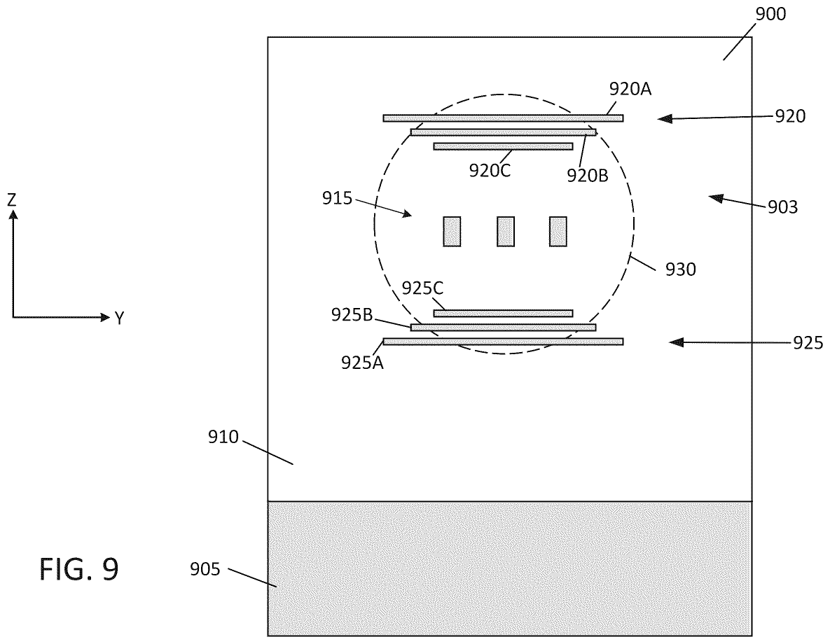

In some example embodiments, each subplate of the plurality of subplates can be formed using vapor deposition (e.g., chemical vapor deposition, atomic layer deposition). In some example embodiments, each subplate has the same approximate thickness that is far below the wavelength of the light propagated in the PIC. For example, the light can be IR light having a wavelength of 1530 nanometers, and first sub-plate 820A and second sub-plate 820B are each 3-100 nanometers thick (with respect to the Z axis), and are separated by a layer of cladding (e.g., a cladding layer a few nanometers thick, a cladding layer tens of nanometers thick) thereby giving the overall thickness of the first plate structure 820 that can be varied to accommodate different matching different mode sizes and shapes (e.g., the first plate structure 820 can be 10 to 50 nanometers thick). Further, in some embodiments, the sub-plate thickness can vary; for example, the first sub-plate 820A can have a thickness of 3 nanometers, and the second sub-plate 820B can have a thickness of 10 nanometers. Further, although only two subplates are illustrated in the example of FIG. 8, in some example embodiments, three or more subplates can be formed to form a single planar waveguide. Further, the length (or “depth” into the PIC extending away from the edge) of the subplates extends from a range of 500 to 1500 μm. Further, each of the subplates can be tapered in length (e.g., FIG. 5A) or rectangular (e.g., FIG. 5B). Further, in some example embodiments, the multi-waveguide coupler structure 803 comprises multiple center waveguides instead of a center single waveguide 815. In some example embodiments, the sub-plates are formed by deposition of an initial thin plate (e.g., second sub-plate 825B, or a subplate nearer to the substrate 805), followed by deposition of cladding on the initial thin plate, followed by deposition of a further thin plate (e.g., first sub-plate 825A) on the cladding, without polishing (e.g., CMP) the cladding that is applied to the initial thin plate (e.g., second sub-plate 825B). Optionally, additional thin plates can be deposited with cladding separating them to form a planar waveguide having two or more thin sub-plates, as discussed in further detail below with reference to FIGS. 9-11.

FIG. 9 shows a cross section view (YZ plane) of PIC 900 comprising a multi-waveguide coupler structure 903 having sub-wavelength plates, in accordance with some example embodiments. In the illustrated example of FIG. 9, the PIC 900 comprises a substrate 905 and cladding material 910 in which the multi-waveguide coupler structure 903 is located. The multi-waveguide coupler structure 903 comprises a first plate structure 920, a second plate structure 925, and center waveguide structure 915 (e.g., comprising three center waveguides). In some example embodiments, the center waveguide structure 915 comprises three or more waveguides that may taper outward (e.g., FIG. 2) or may coalesce into a single waveguide (e.g., as a trident structure, FIG. 6). Additionally, in some example embodiments, the center waveguides comprise multiple layers (with respect to the Z dimension). For example, the middle waveguides comprise an additional upper layer of middle waveguides (not depicted), such as three additional waveguides of similar form and shape as the three middle waveguides of center waveguide structure 915, where the additional waveguides are positioned a few microns above (in Z dimension) the depicted three middle waveguides, and/or a further lower layer of middle waveguides positioned a few microns below the depicted middle waveguides, where the additional upper and lower layers of middle waveguides can taper-in or narrow as they extend away from the edge interface to couple light to the center most of the middle waveguides as the light propagates away from the edge interface.

In some example embodiments, the collective mode size of the multi-waveguide coupler structure 903 is congruent with the fiber mode size 930 such that light is efficiently coupled between the fiber (not depicted in FIG. 9) and the PIC 900. In the example of FIG. 9, the first plate structure 920 and the second plate structure 925 are formed from sub-wavelength plates. For example, the first plate structure 920 comprises a first sub-plate 920A, second sub-plate 920B, and third sub-plate 920C that are thin enough to be below the wavelength of light coupled to the PIC (e.g., IR light). Collectively, the first sub-plate 920A, second sub-plate 920B, and third sub-plate 920C are “seen” by the light as single planar waveguide. That is for, example, collectively the first plate structure 920 functions similar to the first planar waveguide 225 in FIG. 2 but with further mode matching and mode shaping available by the size and position of the first sub-plate 920A and the second sub-plate 920B.

In contrast to FIG. 8, the subplates of FIG. 9 can be tapered or shaped (e.g., with respect to the YZ plane) to shape the mode coupled to the multi-waveguide coupler structure 903. For example, the first sub-plate 920A is wider than the second sub-plate 920B, and the second sub-plate 920B is wider than the third sub-plate 920C, such that the mode is coupled more near the top of the first plate structure 920 than at the bottom of the first plate structure 920. Further, the second plate structure 925 comprises subplates 925A to 925C that similarly can be shaped to couple the mode size near the bottom of second plate structure 925 (the mode is coupled more at subplate 925A than at 925C). In this, the planar waveguide structures of the multi-waveguide coupler structure 903 can be shaped to couple the mode size to better couple the light between a fiber to the PIC.

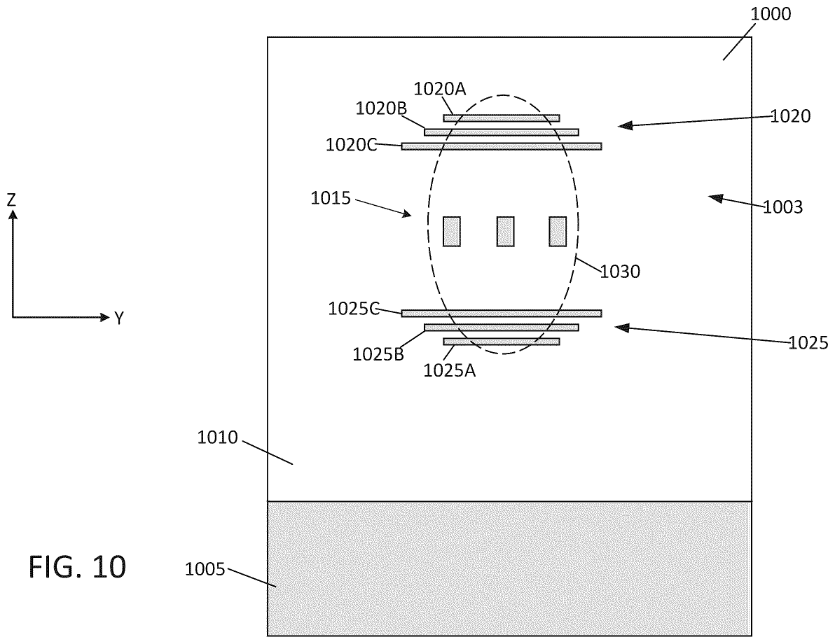

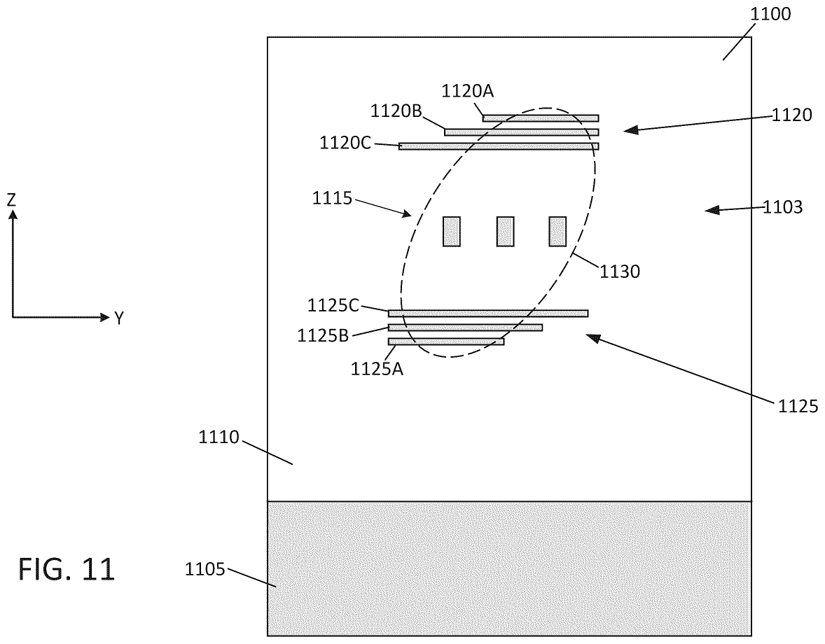

FIGS. 10 and 11 show examples of an non-symmetric mode (e.g., non-circular, asymmetric, elliptical, slanted) being edge-coupled to a photonic integrated circuit having a multi-waveguide structure with couplers including plate structures. FIG. 10 shows a cross section view (YZ plane) of PIC 1000 comprising a multi-waveguide coupler structure 1003 having sub-wavelength plates that couple in a non-symmetric mode. For example, instead of a fiber providing the coupled-in light, the light beam can be provided by a semiconductor laser output, which has an elliptical mode shape. In the illustrated example of FIG. 10, the PIC 1000 comprises a substrate 1005 and cladding material 1010 in which the multi-waveguide coupler structure 1003 is formed. The multi-waveguide coupler structure 1003 comprises a first plate structure 1020, a second plate structure 1025, and center waveguide structure 1015 (e.g., comprising three center waveguides). In some example embodiments, the center waveguide structure 1015 comprises three or more waveguides that may taper outward (e.g., FIG. 2) or may coalesce into a single waveguide (e.g., as a trident structure, FIG. 6).

In some example embodiments, the collective mode size of the multi-waveguide coupler structure 1003 is congruent with the non-symmetric mode 1030 such that light is efficiently coupled between the device providing the beam (e.g., a laser PIC butt-coupled to the PIC 1000). In the example of FIG. 10, the first plate structure 1020 and second plate structure 1025 are formed from sub-wavelength plates. For example, the first plate structure 1020 comprises a first sub-plate 1020A, second sub-plate 1020B, and third sub-plate 1020C that are thin enough to be below the wavelength of light coupled to the PIC (e.g., IR light). Collectively, the first sub-plate 1020A, second sub-plate 1020B, and third sub-plate 1020C are “seen” by the light as single planar waveguide, with an advantage of better coupling-in the mode shape of the non-symmetric mode 1030.

As a non-limiting example of coupling-in the mode shape of the non-symmetric mode 1030, second sub-plate 1020B is wider than the first sub-plate 1020A, and third sub-plate 1020C is wider than the second sub-plate 1020B, thereby more closely matching the top portion of the elliptically shaped non-symmetric mode 1030. Likewise, the second plate structure 1025 comprises subplates 1025A to 1025C that similarly can be shaped to be congruent with the bottom portion of the elliptically shaped non-symmetric mode 1030 (e.g., second sub-plate 1025B is wider than the first sub-plate 1025A, and the third sub-plate 1025C is wider than the second sub-plate 1020B). In this way, the planar waveguide structures of the multi-waveguide coupler structure 1003 can be shaped to couple the mode size to better couple the light between an optical device (e.g., fiber, another PIC having a semiconductor laser, another PIC having a optical amplifier output beam having a elliptical shape) to the PIC 1000.

FIG. 11 shows a cross section view (YZ plane) of PIC 1100 comprising a multi-waveguide coupler structure 1103 having non-symmetric sub-wavelength plates that couple in a non-symmetric angled mode 1130. For example, the mode can be slanted or at an angle as compared to non-symmetric mode 1030 (FIG. 10). For instance, an optical device, such as a semiconductor laser may comprise layers that output an elliptical mode that is at an angle to the vertical axis of the PIC 1100. As illustrated, the multi-waveguide coupler structure 1103 comprises plates that are non-symmetric but rather are formed to be congruent with the received non-symmetric angled mode 1130.

As illustrated, the PIC 1100 comprises a substrate 1105 and cladding material 1110 in which the multi-waveguide coupler structure 1103 is located. The multi-waveguide coupler structure 1103 comprises a first plate structure 1120, a second plate structure 1125, and center waveguide structure 1115 (e.g., comprising three center waveguides). In some example embodiments, the center waveguide structure 1115 comprises one or more waveguides that may taper outward (e.g., FIG. 2) or may coalesce into a single waveguide (e.g., as a trident structure, FIG. 6).

In some example embodiments, the collective mode size of the multi-waveguide coupler structure 1103 is congruent with the non-symmetric angled mode 1130 such that light is efficiently coupled between the device providing the beam (e.g., a laser PIC butt-coupled to the PIC 1100). In the example of FIG. 11, the first plate structure 1120 and the second plate structure 1125 are formed from sub-wavelength plates. For example, the first plate structure 1120 comprises a first sub-plate 1120A, second sub-plate 1120B, and third sub-plate 1120C that are thin enough to be below the wavelength of light coupled to the PIC (e.g., IR light). Collectively, the first sub-plate 1120A, second sub-plate 1120B, and third sub-plate 1120C are “seen” by the light as single planar waveguide with an advantage of better coupling in the mode shape of the non-symmetric angled mode 1130.

As a non-limiting example of coupling-in the mode shape of the non-symmetric angled mode 1130, second sub-plate 1120B is wider than first sub-plate 1120A, and the third sub-plate 1120C is wider than second sub-plate 1120B. Moreover, each of the waveguides is aligned to their respective right-hand edges, thereby more closely matching the top portion of the elliptically shaped non-symmetric angled mode 1130.

Likewise, the second plate structure 1125 comprises subplates 1125A to 1125C that similarly can be shaped to be congruent with the bottom portion of the elliptically shaped non-symmetric angled mode 1130. As a non-limiting example, second sub-plate 1125B is wider than first sub-plate 1125A, and third sub-plate 1125C is wider than the second sub-plate 1120B. Moreover, each of the waveguides is aligned to their respective left-hand edges, thereby more congruent with the non-symmetric angled mode 1130.

In this way, the planar waveguide structures of the multi-waveguide coupler structure 1103 can be shaped to better couple the mode size of the light between optical device (e.g., fiber, another PIC having a semiconductor laser, another PIC having a optical amplifier output beam having a elliptical shape) to the PIC 1100. Further, in some example embodiments, as discussed above, the sub-plates of the plate structures can have the same sub-plate thickness (e.g., 5 nanometers), or different sub-plate thickness (e.g., 3 nanometer thick top sub-plate, 6 nanometer thick middle sub-plate, and 9 nanometer thick bottom sub-plate).

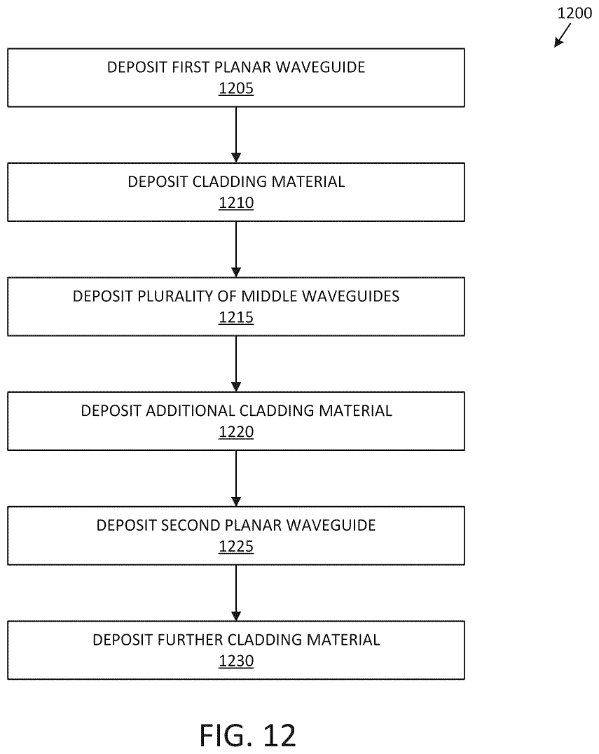

FIG. 12 is a flowchart of an example method 1200 for fabricating a multi-waveguide coupler in a PIC, in accordance with some example embodiments. As shown in FIG. 12, method 1200 may include depositing a first planar waveguide structure (e.g., planar waveguide 230, FIG. 2; plate structure 825, FIG. 8) on a cladding layer of a photonic integrated circuit, where the first planar waveguide extends to an edge of the photonic integrated circuit (operation 1205). For example, material of the first planar waveguide (e.g., silicon, silicon nitride) may be deposited on a cladding layer (e.g., buried oxide, BOX layer, oxide material) of a photonic integrated circuit, where the first planar waveguide extends to an edge of the photonic integrated circuit (to a coupling interface), as described above. In some embodiments, the cladding layer deposited on the substrate is formed such that it has a thickness of at least 10 μm to avoid leakage of the light to the substrate. Further, as discussed above, in some example embodiments, depositing the first planar waveguides comprises alternating deposition of thin plates and cladding, as discussed above.

As also shown in FIG. 12, the method 1200 may include depositing cladding material (e.g., oxide material) on the first planar waveguide (operation 1210). In some example embodiments, the waveguides of the multi-waveguide coupler are thin and polishing (e.g., chemical mechanical polishing (CMP)) is not performed after adding some layers of cladding material thereby improving the manufacturability of the coupler and PIC.

As further shown in FIG. 12, the method 1200 may include depositing a plurality of middle waveguides (e.g., one middle waveguide, three middle waveguides in a same layer, multiple sets of three waveguides) without processing the cladding material due to thinness of the first planar waveguide (operation 1215). In some example embodiments, each middle waveguide extends to the edge of the photonic integrated circuit. For example, a plurality of middle waveguides (e.g., Si waveguides, SiN waveguides) are deposited without processing (e.g., polishing) the cladding material because the planar waveguides are thin (e.g., brittle) and can be affected by polishing. As also shown in FIG. 12, the method 1200 may include depositing additional cladding material on the plurality of middle waveguides (operation 1220). For example, additional cladding material (e.g., oxide material) can be deposited on the plurality of middle waveguides, as described above. In some example embodiments, the middle waveguides are thicker than the planar waveguides, and in some embodiments polishing (CMP) or other processing may be performed after depositing the cladding to ready the structure for deposition of an additional planar waveguide structure.

As further shown in FIG. 12, the method 1200 may include depositing a second planar waveguide (e.g., planar waveguide 225, plate structure 820) on the cladding material (operation 1225). For example, device may deposit a second planar waveguide on the cladding material without first processing the additional cladding material, while in some example embodiments the cladding may be processed by polishing. As also shown in FIG. 12, the method 1200 may include depositing further cladding material on the second planar waveguide (operation 1230). In some example embodiments, the further cladding is thick enough to ensure the mode is confined to the coupler and does not leak through the further cladding (does not leak out a topside of the PIC).

Although FIG. 12 shows example operations of method 1200, in some implementations, method 1200 may include additional operations, fewer operations, different operations, or differently arranged operations than those depicted in FIG. 12. Additionally, or alternatively, two or more of the operations of method 1200 may be performed in parallel.

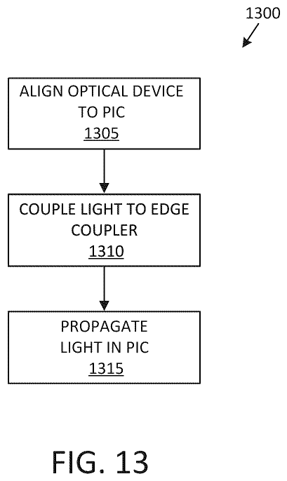

FIG. 13 shows a flow diagram of a method 1300 for implementing a multi-waveguide structure, in accordance with some example embodiments. At operation 1305, light from a device is aligned to a multi-waveguide structure at an edge or side of a PIC. For example, light from a fiber is aligned to the multi-waveguide structure, where the fiber may be held by fiber mount or be fused or bonded to the edge of the PIC. Further, the light may come from another optical device, such as another PIC that has a semiconductor based light source (e.g., semiconductor based laser) that outputs its beam to the multi-waveguide coupler structure of the PIC (e.g., the two PICs may be placed in contact at their edges and optionally bonded together, or separated by an air gap). At operation 1310, light is coupled from the device to the multi-waveguide structure of the PIC. For example, the light from a fiber has a fiber mode shape and size that is congruent with the mode size of the multi-waveguide coupler structure. At operation 1315, the light is propagated away from the edge coupler in the PIC. For example, the light propagates from the edge coupler of the PIC to routing waveguide of the PIC to one or more optical components in the PIC (e.g., optical modulator, single photon detector).

Example 1 is a photonic integrated circuit comprising: a multi-waveguide coupler to couple light to the photonic integrated circuit at an edge coupling interface, the multi-waveguide coupler comprising one or more middle waveguides between a plurality of outer waveguides, the plurality of outer waveguides comprising a first planar waveguide and a second planar waveguide, the first planar waveguide comprising a first plurality of thin planar waveguides; and the second planar waveguide comprising a second plurality of thin planar waveguides.

In Example 2, the subject matter of Example 1 includes, wherein the one or more middle waveguides comprise a plurality of waveguides comprising a center waveguide, a first side waveguide and a second side waveguide.

In Example 3, the subject matter of Example 2 includes, wherein the first side waveguide and the second side waveguide are joined with the center waveguide at a trident coupling in the multi-waveguide coupler.

In Example 4, the subject matter of Examples 1-3 includes, wherein each thin planar waveguide in the first plurality of thin planar waveguides and the second plurality of thin planar waveguides are sub-wavelength plates having a thickness smaller than a waveguide of light that propagates in the photonic integrated circuit.

In Example 5, the subject matter of Examples 1-4 includes, wherein the multi-waveguide coupler comprises a coupling interface to couple light to the photonic integrated circuit.

In Example 6, the subject matter of Example 5 includes, wherein the coupling interface of the multi-waveguide coupler couples light to an optical fiber.

In Example 7, the subject matter of Example 6 includes, wherein at the coupling interface the optical fiber has a first mode size.

In Example 8, the subject matter of Example 7 includes, wherein at the coupling interface the multi-waveguide coupler has a second mode size.

In Example 9, the subject matter of Examples 7-8 includes, wherein the first mode size corresponds to a width of the optical fiber at the coupling interface.

In Example 10, the subject matter of Examples 8-9 includes, wherein the second mode size corresponding to a composite width of the multi-waveguide coupler at the coupling interface.

Example 11 is a method for manufacturing a multi-waveguide coupler comprising: depositing a first planar waveguide on a cladding layer of a photonic integrated circuit, the first planar waveguide extends to an edge of the photonic integrated circuit; depositing cladding material on the first planar waveguide; depositing a plurality of middle waveguides, each middle waveguide extends to the edge of the photonic integrated circuit; depositing additional cladding material on the plurality of middle waveguides; depositing a second planar waveguide on the cladding material, the second planar waveguide extends to an edge of the photonic integrated circuit; and depositing further cladding material on the second planar waveguide.

In Example 12, the subject matter of Example 11 includes, wherein the plurality of middle waveguides are deposited without polishing the cladding material that is deposited on the first planar waveguide, wherein the polishing comprises chemical mechanical polishing (CMP), wherein the method further comprises: polishing the additional cladding material that is deposited on the plurality of middle waveguides.

In Example 13, the subject matter of Examples 11-12 includes, wherein the cladding layer is deposited on a silicon substrate.

In Example 14, the subject matter of Examples 11-13 includes, wherein the plurality of middle waveguides comprises a center waveguide and a plurality of side waveguides.

In Example 15, the subject matter of Examples 11-14 includes, wherein the first planar waveguide comprises a first plurality of thin planar waveguides.

In Example 16, the subject matter of Example 15 includes, wherein the second planar waveguide comprises a second plurality of thin planar waveguides.

In Example 17, the subject matter of Example 16 includes, wherein the first planar waveguide is formed by alternating a deposition of thin planar waveguides with a deposition of cladding layers that separate the thin planar waveguides.

In Example 18, the subject matter of Example 17 includes, wherein the second planar waveguide is formed by alternating a deposition of thin planar waveguides and with a deposition of cladding layers that separate the thin planar waveguides.

In Example 19, the subject matter of Examples 15-18 includes, wherein the first planar waveguide and the second planar waveguide are deposited using vapor deposition.

In Example 20, the subject matter of Examples 15-19 includes, wherein a photonic integrated circuit comprises the multi-waveguide coupler, wherein the multi-waveguide coupler is a first component of the photonic integrated circuit, wherein the photonic integrated circuit comprises a routing waveguide that routes light from the multi-waveguide couplers to a second optical component in the photonic integrated circuit.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A photonic integrated circuit comprising:
a multi-waveguide coupler to couple light to the photonic integrated circuit at an edge coupling interface, the multi-waveguide coupler comprising one or more middle waveguides between a plurality of outer waveguides, the plurality of outer waveguides comprising a first planar waveguide and a second planar waveguide,
the first planar waveguide comprising a first plurality of thin planar waveguides; and
the second planar waveguide comprising a second plurality of thin planar waveguides.

2. The photonic integrated circuit of claim 1, wherein the one or more middle waveguides comprise a plurality of waveguides comprising a center waveguide, a first side waveguide and a second side waveguide.

3. The photonic integrated circuit of claim 2, wherein the first side waveguide and the second side waveguide are joined with the center waveguide at a trident coupling in the multi-waveguide coupler.

4. The photonic integrated circuit of claim 1, wherein each thin planar waveguide in the first plurality of thin planar waveguides and the second plurality of thin planar waveguides are sub-wavelength plates having a thickness smaller than a waveguide of light that propagates in the photonic integrated circuit.

5. The photonic integrated circuit of claim 1, wherein the multi-waveguide coupler comprises a coupling interface to couple light to the photonic integrated circuit.

6. The photonic integrated circuit of claim 5, wherein the coupling interface of the multi-waveguide coupler couples light to an optical fiber.

7. The photonic integrated circuit of claim 6, wherein at the coupling interface the optical fiber has a first mode size.

8. The photonic integrated circuit of claim 7, wherein at the coupling interface the multi-waveguide coupler has a second mode size.

9. The photonic integrated circuit of claim 7, wherein the first mode size corresponds to a width of the optical fiber at the coupling interface.

10. The photonic integrated circuit of claim 8, wherein the second mode size corresponding to a composite width of the multi-waveguide coupler at the coupling interface.

11. A method for manufacturing a multi-waveguide coupler comprising:
depositing a first planar waveguide on a cladding layer of a photonic integrated circuit, the first planar waveguide extends to an edge of the photonic integrated circuit;
depositing cladding material on the first planar waveguide;
depositing a plurality of middle waveguides, each middle waveguide extends to the edge of the photonic integrated circuit;
depositing additional cladding material on the plurality of middle waveguides;
depositing a second planar waveguide on the cladding material, the second planar waveguide extends to an edge of the photonic integrated circuit; and
depositing further cladding material on the second planar waveguide.

12. The method of claim 11, wherein the plurality of middle waveguides are deposited without polishing the cladding material that is deposited on the first planar waveguide, wherein the polishing comprises chemical mechanical polishing (CMP), wherein the method further comprises: polishing the additional cladding material that is deposited on the plurality of middle waveguides.

13. The method of claim 11, wherein the cladding layer is deposited on a silicon substrate.

14. The method of claim 11, wherein the plurality of middle waveguides comprises a center waveguide and a plurality of side waveguides.

15. The method of claim 11, wherein the first planar waveguide comprises a first plurality of thin planar waveguides.

16. The method of claim 15, wherein the second planar waveguide comprises a second plurality of thin planar waveguides.

17. The method of claim 16, wherein the first planar waveguide is formed by alternating a deposition of thin planar waveguides with a deposition of cladding layers that separate the thin planar waveguides.

18. The method of claim 17, wherein the second planar waveguide is formed by alternating a deposition of thin planar waveguides and with a deposition of cladding layers that separate the thin planar waveguides.

19. The method of claim 15, wherein the first planar waveguide and the second planar waveguide are deposited using vapor deposition.

20. The method of claim 15, wherein a photonic integrated circuit comprises the multi-waveguide coupler, wherein the multi-waveguide coupler is a first component of the photonic integrated circuit, wherein the photonic integrated circuit comprises a routing waveguide that routes light from the multi-waveguide couplers to a second optical component in the photonic integrated circuit.
